(19) United States
(12) Patent Application Publication
(10) Pub. No.: US 2004/0045197 A1
(43) Pub. Date: Mar. 11, 2004

(54) Key and corresponding lock identification kit and associated method and system

(76) Inventor: Robert Tomsich, Mayfield Heights, OH (US)

Correspondence Address: PEARNE & GORDON LLP, 1801 EAST 9TH STREET, SUITE 1200, CLEVELAND, OH, 44114-3108, US

(21) Appl. No.: 10/235,972

(22) Filed: Sep. 5, 2002

(51) Int. Cl. G09F 3/00

(52) U.S. Cl. 40/330; 116/201; 116/DIG. 41

(57) ABSTRACT

A novel kit, method, and system for the identification of a key and a corresponding lock. The kit, method, and system involve use of a first sticker and a second sticker, each sticker having an identical identification aspect. The first sticker is placed on a key and the second sticker is placed on a lock. By virtue of the identical identification aspects of the two stickers, a user can identify the key and the corresponding lock.

### FIELD OF THE INVENTION

The invention relates to a kit, method and system for identification of a key and its corresponding lock and more particularly it relates to a kit, method and system for the identification of a key and its corresponding lock through the placement of stickers that have identical identification aspects.

### DESCRIPTION OF RELATED ART

Many doors are secured by use of a lock and key. The lock itself secures the door, whereas the key actuates the lock. The secured door may be part of a home, such as a front door or a door to an individual room, or may be part of an automobile, etc.

Also, a lock and key may be used to secure many other items. The lock may be integrated into an item. For example, a vehicle, such as an automobile or a boat, may have a lock, such as an ignition lock. Also, the lock may be freestanding. For example, a pad lock may be used to secure just about anything.

Often, a multitude of keys are carried, each fitting its corresponding lock. Given the multitude of keys and the fact that the appearance of a key alone is frequently insufficient to enable the user to identify the key for the corresponding lock, the user often must employ the tedious process of testing each key to determine which key actuates the corresponding lock. This process is time intensive. Therefore, it would be useful to provide a kit and method for the identification of a key and a corresponding lock.

### BRIEF SUMMARY OF THE INVENTION

In accordance with one aspect, the present invention provides a kit for the identification of keys and corresponding locks. The kit includes a plurality of stickers. The plurality of stickers includes at least one pair of stickers that have the same identification aspect. The plurality of stickers are adapted for application to keys and corresponding locks.

In accordance with another aspect, the present invention provides a method for identifying a key with a corresponding lock. A first sticker is placed on the key. A second sticker is placed such that the second sticker is associated with the corresponding lock. The first and second stickers have an identical identification aspect to provide for identification of the key and the corresponding lock.

In accordance with another aspect, the present invention provides a system for the identification of a key and a corresponding lock. The system includes a first sticker on the key and a second sticker on the lock. The first and second stickers have an identical identification aspect to provide for identification of the key and the corresponding lock.

### BRIEF DESCRIPTION OF THE DRAWINGS

FIG. 1 is a view of a key with a first sticker affixed thereto in accordance with one aspect of the present invention;

FIG. 2 is a view of a lock, corresponding to the key of FIG. 1, with a second sticker affixed thereto;

FIG. 3 is a view of a chart for recording the identification aspect of the first sticker of FIG. 1 and the second sticker of FIG. 2, in accordance with another aspect of the present invention;

FIG. 4 is a view of a sticker sheet that retains the first sticker of FIG. 1 and the second sticker of FIG. 2, respectively;

FIG. 5 is a view of a kit in accordance with the present invention; and

FIG. 6 is an exploded view of the kit of FIG. 5, showing the opened folder, which has the chart of FIG. 3, and the sticker sheet of FIG. 4.

### DESCRIPTION OF EXAMPLE EMBODIMENTS OF THE INVENTION

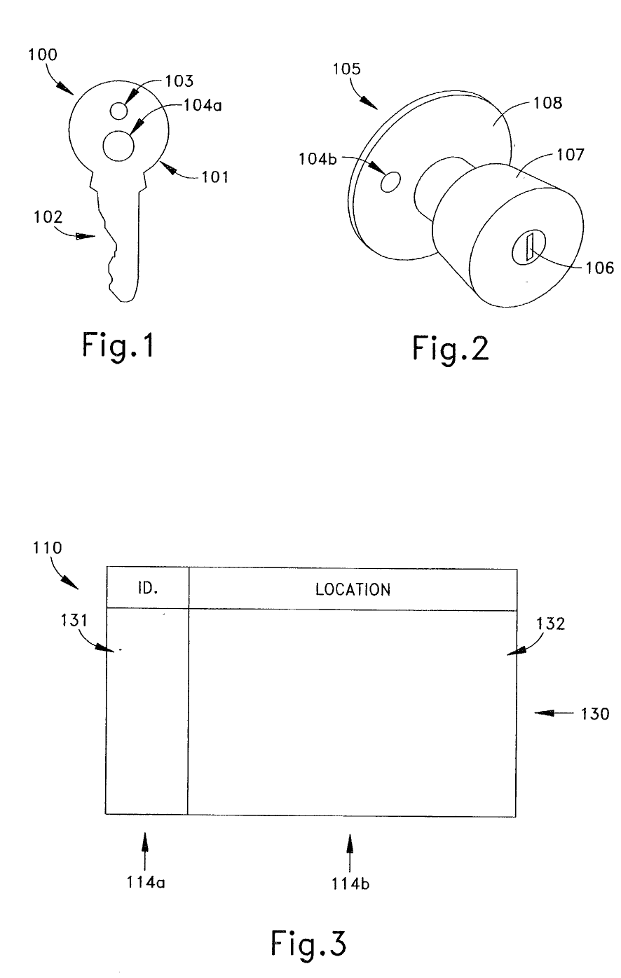

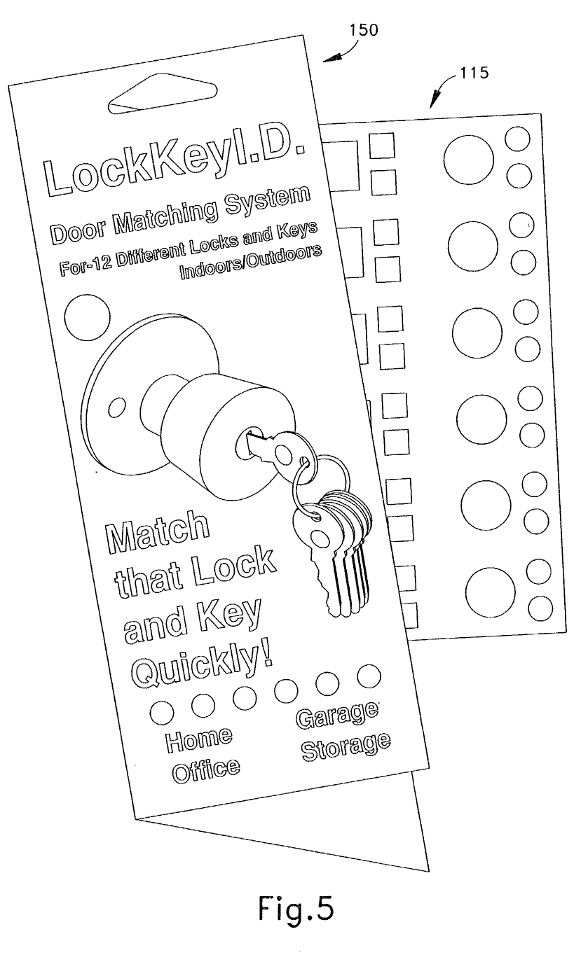

Disclosed herein is a kit 150 (FIG. 5) and method for the identification of a key 100 (FIG. 1) and a corresponding lock 105 (FIG. 2). The key 100 and the corresponding lock 105 are defined as a complimentary key and lock set. The kit and method involve use of the key 100, the corresponding lock 105, a first sticker 104a (FIG. 1) and second sticker 104b (FIG. 1), wherein the first sticker 104a is placed on the key 100 and the second sticker 104b is placed on the corresponding lock 105.

With reference to FIG. 1, the example key 100 is comprised of a blade 102, a head 101 and a ring eyelet 103. The blade 102 is the aspect of the key that engages a lock mechanism (not shown) of the lock 105. The head 101 is attached to an end of the blade 102 distal to an end of the blade 102 that enters the lock. The head 101 is the section of the key 100 grasped by a user to lock and unlock a lock. The ring eyelet 103 is a hole in the head 101 of the key 100 that provides a means for securing the key 100 to a key ring (not shown); however, ring eyelet 103 may be absent. It is understood that only one embodiment of a key is shown and that there are other alternatives for the shape and configuration of a key 100 known in the art.

With reference to FIG. 2, the example lock 105 includes a handle 107, an escutcheon 108 and a key hole 106. The handle 107 is an element of the lock 105 that is turned by a user to open the door (not shown). The handle 107 may be in the form of a knob (as shown) or may be a lever (not shown) or any other form known in the art. The escutcheon 108 is an element of the lock 105 that contributes to the securing of the lock 105 to a door (not shown). The key hole 106 is an aperture through which a user inserts the key blade 102. It is understood that one embodiment of a lock is shown and that there are other alternatives for the shape and configuration of a lock known in the art. For example, the lock may be an ignition lock, a freestanding lock (e.g., a pad lock).

Each sticker 104a, 104b is a slip of paper comprised of two sides, an adhesive side and a non-adhesive side. The adhesive side enables the sticker (e.g., 104a) to be fastened to a surface, such as the key head 101. The non-adhesive side or the entire sticker, according to the invention, has at least one identification aspect that provides for easy identification of the key 100 and the corresponding lock 105. The identification aspect is a color, a shape, or both a color and a shape. Thus, for example, a user, to identify a key 100 and a corresponding lock 105, may select a first red sticker as the first sticker 104a and a second red sticker as the second sticker 104b, from among stickers of different colors, with the identification aspect being the color red. Alternatively, the user may select a first circular sticker as the first sticker 104a and a second circular sticker as the second sticker 104b, from among stickers of different shapes, with the identification aspect being the circular shape. Further, the user may select a first red circular sticker and a second red circular sticker, with the identification aspects being the red color and the circular shape. The above examples are for illustration purposes only and are not intended to limit the scope of the invention.

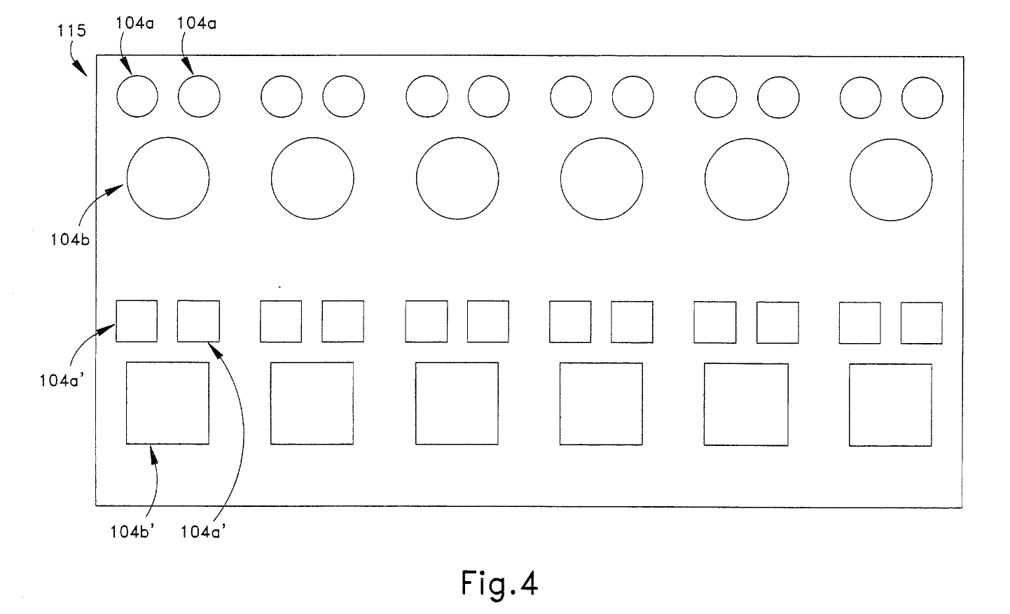

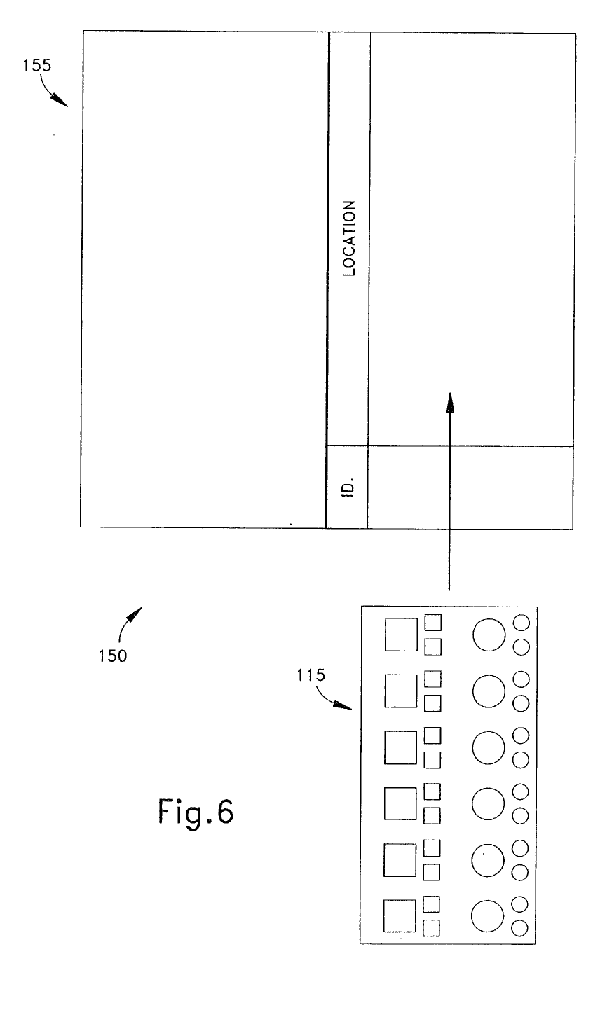

The kit 150 (FIG. 5) is for the identification of the key 100 (FIG. 1) with a corresponding lock 105 (FIG. 2). The example kit 150 (FIG. 6) includes a folder 155, a sticker sheet 115 (FIG. 4) and a chart 110 (FIG. 3). As shown in the example of FIG. 6, the folder 155 houses and contains the sticker sheet 115 and the chart 110. The chart 110 may be printed on the folder 155 itself, as shown in FIG. 6, and the sticker sheet is tucked inside the folder.

As shown in FIG. 4, the example sticker sheet 115 contains a plurality of stickers 104a and 104b. The sticker sheet 115 is constructed of a material that will retain the first sticker 104a and the second sticker 104b and allow removal of the stickers 104a, 104b, while preserving the adhesive material present on the adhesive side of the stickers 104a, 104b. The plurality of stickers 104a, 104b comprises at least two stickers with the same identification aspect. Further, the sticker sheet 115 may contain several sets of two stickers, wherein each set of two stickers has a different identification aspect, than the other sets of stickers.

At least two stickers 104a are provided for convenience and to facilitate identification when more than one key is present for the corresponding lock. Further, sticker sheet 115 contains a first sticker 104a′ and a second sticker 104b′. First sticker 104a′ and second sticker 104b′ are associated with a different identification aspect than the identification aspect associated with the first sticker 104a and the second sticker 104b.

With reference to FIG. 3, the example chart 110 includes a grid with a plurality of columns 114a, 114b and a row 130. The grid of the example chart 110 includes a box 131 for recording the identification aspect of either the first sticker 104a applied to the key 100 or the second sticker 104b applied to the lock 105. It is unimportant whether the identification aspect of the first sticker 104a or the identification aspect of the second sticker 104b is recorded because both are identical. The grid of the example chart 110 also includes a box 132 for recording a descriptor of the second sticker 104b applied to the corresponding lock 105, the identification aspects of which sticker 104b was indicated in the box 131. The descriptor will include information relating to the physical location of the corresponding lock 105. Thus, according to the example chart 110 and one embodiment of the invention, a user will place the first sticker 104a on the key 100. The user will then place the second sticker 104b on the corresponding lock 105. Once the stickers are placed, the user will record the identification aspect of the stickers 104a, 104b in box 131 and will record a descriptor of the second sticker 104b in box 132. Although the chart 110 is shown in FIG. 3 as being able to accommodate the recordation of information relating to one set of the first sticker 104a and the second sticker 104b, it is understood that the chart 110 can be expanded to accommodate the recordation of any number of stickers.

Also disclosed is a method for the identification of the key 100 with the corresponding lock 105 through the use of the first sticker 104a and the second sticker 104b. According to the method a user will remove the first sticker 104a associated with an identification aspect from the sticker sheet 115 and place the first sticker 104a on the key 100. In one example, the first sticker 104a will be placed on the key head 101 of the key 100. However, the first sticker 104 may be placed on any spot of the key 100 that is convenient. The user then removes the second sticker 104b from the sticker sheet 115 and places the second sticker 104b on or near the corresponding lock 105 for the key 100. The user selects the first sticker 104a and the second sticker 104b so that the identification aspect of the first and second stickers 104a and 104b will enable the user to identify the key 100 and the corresponding lock 105 (e.g., the user selects a pair of stickers having the same identification aspect such as the same color, the same shape or both the same color and the same shape).

The method for the identification of the key 100 with the corresponding lock 105 through the use of the first sticker 104a and the second sticker 104b further includes the recordation in box 131 of the chart 110 the identification aspect of the first sticker 104a placed on the key 100 and the second sticker 104b placed on the corresponding lock 105. The method further comprises the recordation in box 132 of the chart 110 the descriptor of the second sticker 104b placed on the corresponding lock 105.

One benefit of the kit and method is to enable a user holding a set of keys to quickly identify a key and its corresponding lock. Thus, according to the invention, the user's keys will each have affixed thereto a sticker associated with an identifier. The corresponding locks for each of the keys will also have affixed thereto or nearby a sticker associated with an identifier. Each key and its corresponding lock will bear a sticker associated with the same identifier; alternatively, the user may select any combination of stickers according to the user's preferences. By observing the stickers, the user will be able to quickly and easily select the appropriate key when presented with the corresponding lock.

Although the preferred embodiments have been described, it is understood that various modifications may be resorted to without departing from the scope of the invention as disclosed and claimed herein.

What is claimed is:

1. A kit for the identification of keys and corresponding locks, comprising:
a plurality of stickers, the plurality of stickers comprising at least one pair of stickers having the same identification aspect;
wherein the plurality of stickers is adapted for application to keys and corresponding locks.

2. The kit of claim 1, further comprising means for recording a location of the pair of stickers.

3. The kit of claim 1, wherein the identification aspect is a color.

4. The kit of claim 1, wherein the identification aspect is a shape.

5. The kit of claims 1, wherein the identification aspect is a shape and a color.

6. A method for identifying a key with a corresponding lock, comprising the steps of:
placing a first sticker on the key; and
placing a second sticker such that the second sticker is associated with the corresponding lock;
wherein the first and second stickers have an identical identification aspect to provide for identification of the key and the corresponding lock.

7. The method of claim 6, further comprising:
recording on a recording means a descriptor associated with the pair of stickers.

8. The method of claim 6, wherein the identification aspect is a color.

9. The method of claim 6, wherein the identification aspect is a shape.

10. The method of claims 6, wherein the identification aspect is a shape and a color.
